(19) United States
(12) Patent Application Publication
(10) Pub. No.: US 2025/0116971 A1
(43) Pub. Date: Apr. 10, 2025

(54) SYSTEM FOR CONTROLLING A DEVICE PROVIDED WITH AT LEAST ONE REDUNDANT SENSOR FOR DETECTING AND ISOLATING FAILURES IN ONE OF THE SENSORS

(71) Applicant: SAFRAN AIRCRAFT ENGINES, Paris (FR)

(72) Inventors: Seif Eddine Benattia, Moissy-Cramayel (FR); Pierre Cabrera, Moissy-Cramayel (FR)

(73) Assignee: SAFRAN AIRCRAFT ENGINES, Paris (FR)

(21) Appl. No.: 18/730,272

(22) PCT Filed: Jan. 16, 2023
(86) PCT No.: PCT/FR2023/050056

§ 371 Date: Jul. 18, 2024

(30) Foreign Application Priority Data
Feb. 1, 2022 (FR) FR2200875

(51) Int. Cl. G05B 9/03; G05B 23/02

(52) U.S. Cl. CPC G05B 9/03; G05B 23/0254

(57) ABSTRACT

System for controlling a device provided with at least one equipment item, the control system comprising at least one sensor capable of measuring operating quantities of the device, and two specific channels for measuring a redundant sensor for each equipment item, at least one embedded control means configured to determine a command intended for at least one equipment item as a function of the at least one measurement of the operating quantity of the device and a selected measurement of the controlled equipment item, the control system further comprising a calculating means configured to determine the selected measurement of the at least one controlled equipment item, by means of a Kalman filter observer, as a function of the at least one measurement of the operating quantity of the device and the measurements of the two specific channels for measuring a redundant sensor for the controlled equipment item.

### TECHNICAL FIELD

The technical field of the invention relates to control systems, and more precisely observer control systems.

### PRIOR ART

The systems for controlling an aircraft engine according to the prior art do not make it possible to locate a bias or a drift of one of the channels for measuring a redundant sensor. Indeed, during a “cross check” failure, determined by a deviation between measurement channels higher than a threshold, an arbitrary selection of the channel having the minimum value, of the channel having the maximum value or of an average of the two measurement channels is then performed. Therefore, there is a risk of continuing to use an erroneous measurement or a value dependent on this erroneous measurement. The control systems of the prior art only make it possible to detect the failure and not to locate it.

The following documents are known from the prior art.

The document US20200201312 discloses technology for isolating and detecting failures on aeronautical airspeed sensors (Total pressure, Static pressure, etc.). To achieve this, it is described to use a bank of KALMAN filters and its residuals (i.e. deviations between the estimated measurement and the actual measurement) coupled with a truth table to detect and isolate a failed sensor and to reconfigure it on its model in the event of a fault.

The document CN110118128 describes similar information but based on a particular forming of the residuals (WSSR: Weighted Sum of Squares of Residuals) for the isolation and the detection.

The document US2009043447 also describes similar information, but based on different indicators (delta on averages of the evolutions of the states and/or residuals) for detecting and isolating failures. In addition, in the case where the failed sensor cannot be isolated, a probabilistic approach (occurrence of failures) is used.

These various documents of the prior art make it possible to detect the fault of a sensor from a set of sensors measuring different physical quantities. Moreover, these various documents are based on various Kalman filter architectures in the form of “banks”: a plurality of different Kalman filters are used with the same sensors and the interpretation of the residuals (i.e. deviations between the outputs of the model and the sensor measurements) makes it possible to detect the sensor of a failed physical quantity.

The document B. M. De Silva et al. is also known disclosing a system for determining the failure of a sensor based on a Kalman filter.

The document describes the determination of estimated values of the measurements of a redundant sensor, and the determination of a failure through the evolution of a movable means of the innovation matrix. The system comprises offline steps for calibrating a model and for training a decision tree based on a training set, and online steps, applied to sensor measurements. During the online steps, values expected by the decision tree are determined by using the system determined during the offline steps, then the expected values are transmitted to the decision tree in order to obtain a prediction relating to the failure of one of the sensors of the set of sensors. The document is thus limited to the detection of the failure of a sensor, and does not mention channels for measuring a redundant sensor or the control of an actuator.

The technical problem to be solved is how to detect a failure of one of the channels for measuring a redundant sensor and exclude the failed measurement channel for the redundant sensor by a command by means of a Kalman filter observer.

### DISCLOSURE OF THE INVENTION

One object of the invention is a system for controlling a device provided with at least one equipment item, the control system comprising at least one sensor each capable of measuring an operating quantity of the device, and two channels for measuring a redundant sensor for each equipment item, at least one embedded control means configured to determine a command intended for at least one equipment item as a function of the measurement of at least one operating quantity of the device and a selected measurement of the controlled equipment item, the control system further comprising a calculating means configured to determine the selected measurement of the at least one controlled equipment item, by means of a Kalman filter observer, as a function of the at least one measurement of the operating quantity of the device and the measurements of the channels for measuring a redundant sensor for the controlled equipment item, the calculating means being further configured to detect a failure of one of the channels for measuring the specific redundant sensor so as to exclude therefrom the measurement channel.

The device may comprise at least two equipment items, the selected measurement of the at least two equipment items being determined by the same Kalman filter observer.

The calculating means may comprise:
a Kalman filter observer determining an estimation of a bias of the first measurement channel and an estimation of a bias of the second measurement channel as a function of the at least one measurement of the operating quantity of the device, of the first channel for measuring the redundant sensor and of the second channel for measuring the redundant sensor,
a comparison means configured to send a selection signal as a function of the comparison results of each bias estimation at a first predetermined threshold, of the result of the comparison of the absolute value of the difference of two measurement channels at a second predetermined threshold and of the bias estimations with one another, and
a selection device configured to transmit the selected measurement equal to the measurement of the first channel for measuring the redundant sensor, to the measurement of the second channel for measuring the redundant sensor or to the average of the measurements of the two channels for measuring the redundant sensor as a function of a selection signal.

The selection device may comprise a calculating means configured to perform the average of the measurement of the first measurement channel and the measurement of the second measurement channel, the selection device also comprising a logic gate receiving as input on the one hand the selection signal and on the other hand the measurement of the first measurement channel, the measurement of the second measurement channel and the average of the measurements of the measurement channels, the logic gate being configured to send the selected measurement equal to one of the values received as input as a function of the selection signal.

The comparison means may be configured to perform the following steps:
when the absolute value of the difference between the measurement of the first measurement channel and the measurement of the second measurement channel is lower than a second predetermined threshold or none of the bias estimations are higher than a first predetermined threshold, the selection signal sent indicates to the selection device to transmit a selected measurement equal to the average of the measurements of the channels for measuring the redundant sensor,
when the absolute value of the difference between the measurement of the first measurement channel and the measurement of the second measurement channel is higher than a second predetermined threshold and the estimation of the bias of the first measurement channel is not higher than a first threshold, and the estimation of the bias of the second measurement channel is higher than the first threshold, the selection signal sent indicates to the selection device to transmit a selected measurement equal to the measurement of the first channel for measuring the redundant sensor,
when the absolute value of the difference between the measurement of the first measurement channel and the measurement of the second measurement channel is higher than a second predetermined threshold and the estimation of the bias of the first measurement channel is higher than the first threshold, and the estimation of the bias of the second measurement channel is not higher than the first threshold, the selection signal sent indicates to the selection device to transmit a selected measurement equal to the measurement of the second channel for measuring the redundant sensor,
when the absolute value of the difference between the measurement of the first measurement channel and the measurement of the second measurement channel is higher than a second predetermined threshold and the estimation of the bias of the first measurement channel is higher than the first threshold, when the estimation of the bias of the second measurement channel is higher than the first threshold, and when the estimation of the bias of the first measurement channel is not higher than the estimation of the bias of the second measurement channel, the selection signal sent indicates to the selection device to transmit a selected measurement equal to the measurement of the first channel for measuring the redundant sensor,
when the absolute value of the difference between the measurement of the first measurement channel and the measurement of the second measurement channel is higher than a second predetermined threshold and the estimation of the bias of the first measurement channel is higher than the first threshold, when the estimation of the bias of the second measurement channel is higher than the first threshold, and when the estimation of the bias of the first measurement channel is higher than the estimation of the bias of the second measurement channel, the selection signal sent indicates to the selection device to transmit a selected measurement equal to the measurement of the second channel for measuring the redundant sensor.

The comparison means may be configured to perform the following steps: the estimations of the biases are stored at the moment when it is determined that the difference in absolute value between the measurement of the first measurement channel and the measurement of the second measurement channel is higher than a predetermined threshold and a selection signal is sent indicating to the selection device to transmit a selected measurement equal to the measurement of the channel for measuring the redundant sensor for which the absolute value of its estimation of the bias is the lowest.

The comparison means may be configured to perform the following steps: the estimations of biases are stored on a sliding window over time, when a predefined number of values are stored, the variance or the standard deviation of the estimations of the bias of the first measurement channel is determined and the variance or the standard deviation of the estimations of the bias of the second measurement channel is determined, the variances or the standard deviations obtained are compared and a selection signal is sent indicating to the selection device to transmit a selected measurement equal to the measurement of the channel for measuring the redundant sensor for which the variance or the standard deviation of the associated bias estimation takes the lowest value.

The comparison means may be configured to perform the following steps: the bias estimations are stored over time, when a predefined number of values are stored, the gradient of the estimations of the bias of the first measurement channel is determined and the gradient of the estimation of the bias of the second measurement channel is determined, the gradients obtained are compared and a selection signal is sent indicating to the selection device (5c) to transmit a selected measurement equal to the channel for measuring the redundant sensor for which the gradient of the estimations of the associated bias is the lowest.

The controlled equipment item may be an actuator, the system then comprising a Kalman filter observer determining an estimation of the bias of the first measurement channel and an estimation of the bias of the second measurement channel as a function of the at least one measurement of the operating quantity of the device, of the measurement of the first channel for measuring the redundant sensor and of the measurement of the second channel for measuring the redundant sensor, a detection device comprising:

a first subtractor determining the difference between the measurement of the first channel for measuring the redundant sensor and the measurement of the second channel for measuring the redundant sensor,
first comparison means determining whether the difference between the measurement of the first channel for measuring the redundant sensor and the measurement of the second channel for measuring the redundant sensor is lower than a second threshold, if such is the case the first comparison means sends a first signal intended for a logic gate,
a second comparison means determining whether the estimation of the bias of the first measurement channel is higher than a third threshold, if such is the case the second comparison means sends a first signal intended for the logic gate,
a third comparison means determining whether the estimation of the bias of the second measurement channel is higher than the third threshold, if such is the case the third comparison means sends a first signal intended for the logic gate,
a second subtractor determining the difference between the estimation of the bias of the first measurement channel and the estimation of the bias of the second measurement channel,
a fourth comparison means determining whether the difference between the estimation of the bias of the first measurement channel and the estimation of the bias of the second measurement channel is higher than a fourth threshold, with a hysteresis taking into account the accuracy of the two channels for measuring the redundant sensor, if such is the case the fourth comparison means sends a first signal intended for the logic gate,
the logic gate transmitting a first signal when all of its inputs receive a first signal, the logic gate transmitting a second signal when all of its inputs do not receive the first signal, which makes it possible to detect the actuation failure.

The device may be an aircraft engine and the channels for measuring the redundant sensor measure the position of the linear variable differential transformers, the position of the fuel dosing valve, the variable stator valves of the high-pressure compressor of the engine, the measurement of the input temperature of the high-pressure compressor of the engine, or the input static pressure measurement of the combustion chamber of the engine.

Another object of the invention is a method for controlling a device provided with at least one equipment item, at least one sensor capable of measuring an operating quantity of the device, and channels for measuring the redundant sensor for each equipment item, the control method comprising the following steps of:
determining a command intended for at least one equipment item as a function of the at least one measurement of the operating quantity of the device and a selected measurement of the controlled equipment item, then
determining the selected measurement of the at least one controlled equipment item, by means of a Kalman filter observer, as a function of the at least one measurement of the operating quantity of the device and measurements of the channels for measuring the redundant sensor for the controlled equipment item.

Another object of the invention is an aircraft provided with a control system or comprising a control method as described above.

### BRIEF DESCRIPTION OF THE DRAWINGS

Other aims, features and advantages of the invention will become apparent upon reading the following description, given solely by way of non-limiting example, and made with reference to the appended drawings wherein:

FIG. 1 illustrates the main elements of a control system based on a Kalman filter,

FIG. 2 illustrates the main elements of the calculating means configured to determine the bias estimations in the control system according to the invention, and

FIG. 3 illustrates an alternative selection device applied to the detection of actuation failures in the control system according to the invention.

### DETAILED DESCRIPTION

The control system according to the invention is based on the use of the same Kalman filter (but supplied by different measurement channels) in order to detect and locate a single failure of a redundant sensor in order to accommodate the acquisition on the healthy channel instead of arbitrarily choosing a channel and potentially selecting the wrong channel. In an application to an aircraft, and to the control of an aircraft engine, it is then possible to avoid an engine event, such as a Loss of Thrust Control (LOTC).

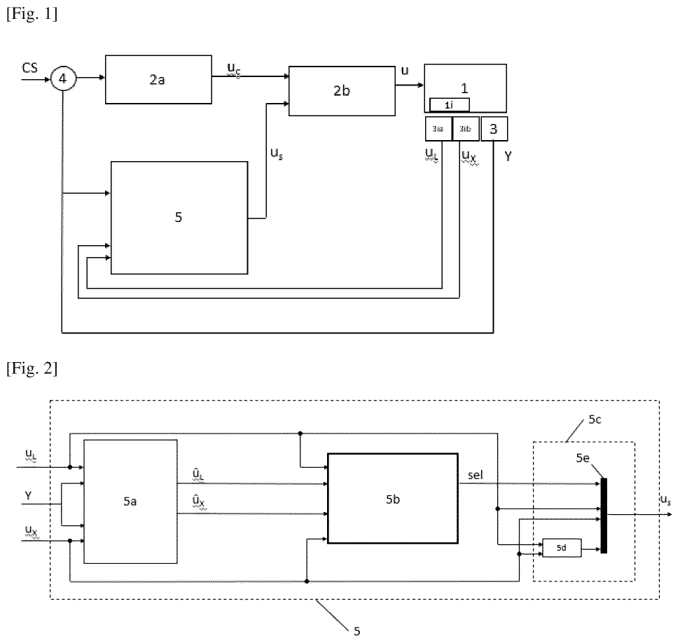

FIG. 1 illustrates the main elements of a control system based on a Kalman filter observer.

A device 1, such as an aircraft engine, is controlled by a control means 2a,2b as a function of the difference between a setpoint CS of an operating parameter of the device 1 (for example, the rotation speed in the case of an engine) and a measurement Y by a sensor 3 of the operating parameter of the device 1 corresponding to the setpoint CS.

The difference between the setpoint CS and the measurement Y is determined by means of a subtractor 4.

The first control means 2a may be an open-loop or closed-loop control means and makes it possible to determine the command u_{c}. The second control means 2b is a closed-loop control means.

More precisely, the first control means 2a makes it possible to determine a control setpoint u_{c} as a function of the difference between the setpoint CS and the measurement Y when the first control means 2a is a closed-loop control means. The first control means 2a makes it possible to determine a control setpoint u_{c} as a function of the measurement Y when the first control means 2a is an open-loop control means. This control setpoint u_{c} is received by a second control means 2b in order to determine a command u of at least one device 1i by taking into account a selected measurement uS received from a calculating means 5 comprising an observer based on a Kalman filter 5a.

It will be understood that the use of two control means 2a, 2b makes it possible to control a plurality of distinct equipment items 1i acting on the devices as a function of the measurement Y and/or of the setpoint CS according to the structure of the first control means 2a. In the case of an aeronautical engine thus controlled, the controlled equipment items 1i may be the fuel metering valve or the variable-geometry vanes of said engine. These equipment items contribute to the operation of the engine, and to the performance of the command, for example the rotation speed of the engine. Thus, it is understood that to perform the setpoint CS through the measurement Y, the command u is of the vector type, and comprises a selected measurement intended for each equipment item 1i of the device 1. It should be noted that the quantities u_{c}, uₛ, CS, Y, u_{L} and uₓ may be vectors.

In order to ensure that each equipment item 1i performs the command determined by the second control means 2b, measurement channels 3ia, 3ib specific to each equipment item 1i are used. Each pair of measurement channels 3ia, 3ib is from the redundancy of a measurement sensor and from its acquisition chain. Thus, they measure the same quantity so that the measurement is always available even in the event of failure of one of the channels 3ia, 3ib for measuring a specific redundant sensor. The measurements of the first channel 3ia for measuring a plurality of sensors (with i varying 1 to j) may be concatenated in the vector u_{L}. The measurements of the second channel 3ib for measuring a plurality of sensors may be concatenated in the vector uₓ. In FIG. 1, a single equipment item 1i is illustrated for the purpose of legibility. It will be understood that an aircraft engine is generally provided with multiple equipment items 1i, each provided with a pair of specific redundant sensors 3ia, 3ib.

Nevertheless, this redundancy then poses the problem of determining the measurement channels 3ia, 3ib to be taken into account in the calculation of the selected measurement uₛ to be transmitted to the second control means 2b.

Indeed, the simple cases such as the absence of a signal or of identical signals may be treated with logic operators. Nevertheless, the more complex cases such as a drift or bias of a channel for measuring a sensor cannot be treated in this way.

The calculating means 5 receives as input the measurements u_{L}, uₓ of the channels 3ia, 3ib for measuring the redundant sensor and one or more measurements Y of the sensor 3. It sends as output the selected measurement signal uₛ intended for the second control means 2b. The calculating means 5 comprises an observer based on a Kalman filter, making it possible to determine the selected measurement us as a function of the signals of the sensors uL, uX, Y. The observer is built from a model representative of the device 1 observed and of the at least one equipment item 1i and makes it possible to isolate a faulty measurement channel coming from one of the channels 3ia, 3ib for measuring a redundant sensor measuring each equipment item 1i.

The selected measurement uₛ is obtained by adding additive biases on the inputs u_{L}, uₓ. The Kalman filter then makes it possible, by varying in real time the additive biases on each of the inputs of the model, to converge the outputs of the model with the engine measurements Y. The convergence makes it possible to obtain a zero residual. The biases obtained then directly represent the deviation between the actual measurement of the controlled equipment item (determined by observation via its effect on the device) and the chosen measurement u_{L}, uₓ from one of the measurement channels 3ia, 3ib of the sensor.

The adjustment of the performance of the filter (gains) is performed in an optimal manner through the resolution of a standard problem (for example, algebraic RICCATI equation).

More precisely, the calculating means 5 performs the estimation of the biases associated with each channel 3ia or 3ib for measuring the redundant sensor.

When the bias estimation associated with a channel 3ia or 3ib for measuring the redundant sensor exceeds a first maximum predefined threshold, the channel 3ia or 3ib for measuring the redundant sensor is declared as failed. The observer then uses the measurements provided by the other channel 3ia or 3ib for measuring the redundant sensor. This arbitration may be carried out in the form of a truth table.

FIG. 2 illustrates the main elements of the calculating means 5.

The calculating means 5 comprises a Kalman filter observer referenced 5a, a comparison means 5b, and a selection device referenced 5c.

The observer 5a makes it possible to determine, by taking into account one or more measurements Y, an estimation of the bias of the first measurement channel ûl corresponding to the measurement u_{L} of the first channel 3ia measuring the redundant sensor and an estimation of the bias of the second measurement channel ûₓ corresponding to the measurement uₓ of the second channel 3ib measuring the redundant sensor.

The comparison means 5b is configured to determine a selection signal, denoted sel, as a function of the comparison of the estimation of the bias of the first measurement channel û_{L} with a first threshold α, of the estimation of the bias of the second measurement channel uₓ with a first threshold α, and of the estimation of the bias of the first measurement channel u with the estimation of the bias of the second measurement channel ûx. The Boolean signals associated with these comparisons are transmitted to a predetermined truth table so as to determine the selection signal sel of the value to be transmitted as selected measurement uₛ.

For example, if the value 1 is attributed to a verified comparison, and the value 0 is attributed to a comparison that is not verified, then the truth table comprises the values illustrated by the table [Table 1].

TABLE 1

| ûₗ > α | ûₓ > α | ûₗ > ûₓ | sel |
|---|---|---|---|
| 0 | 0 | N/A | (uₗ + uₓ)/2 |
| 0 | 1 | N/A | uₗ |
| 1 | 0 | N/A | uₓ |
| 1 | 1 | 0 | uₗ |
| 1 | 1 | 1 | uₓ |

The first three columns correspond to the inputs of the table, the last column corresponding to the selection signal determined by the table.

Thus when none of the estimations of the bias are higher than the first predetermined threshold α, the selected value is the average of the measurements of the measurement channels (3ia, 3ib) (u_{L}+uₓ)/2.

When the estimation of the bias of the first measurement channel û_{L} is not higher than the first threshold α, and the estimation of the bias of the second measurement channel ûₓ is higher than the first threshold α, the selected value is the measurement of the first measurement channel uₗ.

When the estimation of the bias of the first measurement channel û is higher than the first threshold α, and the estimation of the bias of the second measurement channel ûₓ is not higher than the first threshold α, the selected value is the measurement Uₓ of the second measurement channel.

When the estimation of the bias of the first measurement channel û is higher than the first threshold α, when the estimation of the bias of the second measurement channel ûₓ is higher than the first threshold «, and when the estimation of the bias of the first measurement channel u is not higher than the estimation of the bias of the second measurement channel uₓ, the selected value is the first measurement of the first measurement channel uₗ.

When the estimation of the bias of the first measurement channel ûₗ is higher than the first threshold α, when the estimations of the bias of the second measurement channel ûₓ is higher than the first threshold α, and when the estimation of the bias of the first measurement channel ûₗ is higher than the estimation of the bias of the second measurement channel ûₓ, the selected value is the second measurement uₓ of the second measurement channel.

As a function of the result of the comparison, the selection signal sel is then transmitted to the selection device 5c also receiving as input the measurement uₗ of the first measurement channel (3ia) and the measurement uₓ of the second measurement channel (3ib).

The selection device 5c comprises a calculating means 5d configured to perform the average of the measurement uₗ of the first measurement channel (3ia) and of the measurement uₓ of the second measurement channel (3ib).

The selection device 5c also comprises a logic gate 5e receiving as input on the one hand the selection signal sel and on the other hand the measurement uₗ of the first measurement channel (3ia), the measurement uₓ of the second measurement channel (3ib) and the average of the measurement uₗ of the first measurement channel (3ia) and of the measurement uₓ of the second measurement channel (3ib).

As a function of the selection signal sel received and the comparison of the absolute value of the difference between the measurement uₗ of the first measurement channel (3ia) and the measurement uₓ of the second measurement channel (3ib) in relation to a second predefined threshold β, the selection device 5c transmits the measurement uₗ of the first measurement channel (3ia), the measurement uₓ of the second measurement channel (3ib) or the average of the measurement uₗ of the first measurement channel (3ia) and of the measurement uₓ of the second measurement channel (3ib) in the form of the selected measurement signal uₛ.

[Table 2] below illustrates the truth table resulting from the actions of the comparison means 5b and of the selection device 5c.

TABLE 2

| \|uₗ − uₓ\| > β | ûₗ > α | ûₓ > α | ûₗ > ûₓ | sel |
|---|---|---|---|---|
| 0 | N/A | N/A | N/A | (uₗ + uₓ)/2 |
| 1 | 0 | 0 | N/A | (uₗ + uₓ)/2 |
| 1 | 0 | 1 | N/A | uₗ |
| 1 | 1 | 0 | N/A | uₓ |
| 1 | 1 | 1 | 0 | uₗ |
| 1 | 1 | 1 | 1 | ux |

The control system has been described in relation to a single quantity measured by two specific channels 3ia, 3ib for measuring a redundant sensor. Nevertheless, the control system can be extended to at least two quantities each measured by two specific channels for measuring redundant sensors. In this case, the same Kalman filter observer 5a is used in order to determine the estimation of the bias of the measurement channels for each quantity supported.

For each quantity, there are then two bias estimations, a comparison means with its own truth table and with its own comparison threshold, as well as a selection means.

The control system makes it possible to:
isolate, for each redundant sensor, the failed channel from the healthy channel and to thus be able to reconfigure,
use the same Kalman filter supplied by different measurement channels. Thus, as opposed to the prior art that uses a bank of different Kalman filters, this makes it possible to optimise the control system (reduction of the impact on the memory or the load CPU)
obtain an estimation of the bias directly dependent on the measurements and easy to interpret subsequently (as opposed to the residuals used in the prior art)

Applied to an aircraft, and particularly to the control of an engine of an aircraft, the control system makes it possible to be robust to the failure during the flight and to provide a diagnostic for replacement at the end of the mission.

In a first alternative embodiment, the control system according to the invention makes it possible to take into account the accuracy of the model embedded in the Kalman filter in order to distinguish it from the effects of drifts of the channels 3ia, 3ib for measuring the redundant sensor.

The model embedded in the Kalman Filter has a certain accuracy that directly impacts the performances for estimating the biases. Indeed, although the embedded model is not perfect, the estimation of the bias by the Kalman filter can be broken down in the following manner:

$$\hat{u} = u + {ϵ}_{m d l}$$

Where:
û→Bias estimated by the Kalman Filter
u→Actual bias seen by the physical system
∈_{mdl}→Modelling error

As opposed to the preceding embodiment wherein the estimation of the bias is compared “in absolute” with a first threshold, this alternative embodiment comprises a “relative” comparison of the absolute value of the local (|û_{L}|) and cross (|û_{X}|) estimation of the biases.

This alternative embodiment is based on the observation that the modelling error varies little over time. It may concern, for example, the ageing of the device 1. This modelling error is also identical in the bias estimation corresponding to the channels 3ia, 3ib for measuring the redundant sensor because these bias estimations are estimated from the same Kalman Filter (and therefore with the same embedded model).

Indeed, in the example where the disturbances |û_{L}| and |û_{X}| are positive, this gives:

$$\vert {\hat{u}}_{L} \vert - \vert {\hat{u}}_{X} \vert = {u}_{L} + {ϵ}_{mdl \_ L} - {u}_{X} - {ϵ}_{mdl \_ X} = {u}_{L} - {u}_{X}$$

Where:
û_{L}→Estimation of the bias by the Kalman Filter from measurements of the local channel
û_{X}→Estimation of the bias by the Kalman Filter from measurements of the cross channel
u_{L}→Actual bias seen on the measurement of the local channel
u_{X}→Actual bias seen on the measurement of the cross channel.
∈_{mdl_L}=∈_{mdl_X}→Modelling error (identical)

Consequently, the sign of the comparison |û_{L}|−|û_{X}| determines which measurement is the furthest from the actual physical quantity and therefore which measurement has drifted in spite of the modelling error. The selection signal sent makes it possible to disregard the value coming from the sensor having drifted too much.

In this embodiment, the bias estimations are stored at the moment when it is determined that the difference in absolute value between the first measurement channel uₗ and the second measurement channel uₓ is higher than the threshold β, in order to have a reference. The sign of the comparison |û_{L}|−|û_{X}| is then determined.

If the sign is positive, a selection signal is sent making it possible to choose the second measurement uₓ as selected measurement uₛ.

If the sign is negative, a selection signal is sent making it possible to choose the first measurement u_{L} as selected measurement uₛ.

In a second alternative embodiment, the control system according to the invention makes it possible to compare the evolution of the variance or of the standard deviation of the two biases to prevent the dispersion effects from hiding the failure of specific sensors.

As presented above, the estimations of the biases comprise a common modelling error. To the nearest imprecision of the measurements of specific redundant sensors 3ia, 3ib, the evolution of the variance (or standard deviation) of the two bias estimations is therefore almost identical. Consequently, if the evolution of the variance (or standard deviation) of one of the two bias estimations is much faster than that of the other bias estimation, then the measurement associated with this bias estimation is subjected to a drift. The corresponding measurement channel has therefore failed.

This embodiment particularly makes it possible to cover the case where the failure has an effect on the measurement compensating the modelling error and potentially making it more difficult to locate the failure with the first alternative embodiment.

To achieve this, the bias estimations are stored on a sliding window û_{L}, û_{X} with each iteration of the Kalman filter observer. When the predefined number of values are stored, the variance or the standard deviation of the estimations of the bias of the first measurement channel û_{L} is determined and the variance or the standard deviation of the estimations of the bias of the second measurement channel is determined û_{X}.

The variances or the standard deviations obtained are compared and a selection signal is sent designating the channel for measuring the redundant sensor for which the variance or the standard deviation of the associated estimation of the bias takes the lowest value.

In a third alternative embodiment, the control system according to the invention makes it possible to compare the evolution of the gradient of the two bias estimations in order to take into account drifts of the system.

As for the second alternative embodiment, the bias estimations are stored û_{L}, û_{X} with each iteration of the Kalman filter observer. When the predefined number of values are stored, the gradient of the estimations of the bias of the first measurement channel û_{L} is determined and the gradient of the estimations of the bias of the second measurement channel is determined û_{X}.

The gradients thus obtained are compared and a selection signal is sent designating the channel for measuring the redundant sensor for which the gradient of the associated estimation of the bias is the lowest value.

It is also possible to configure the control system according to the invention in order to detect the actuation failures. In the case of an aeronautical engine, the actuation failures of a fuel metering valve can be cited.

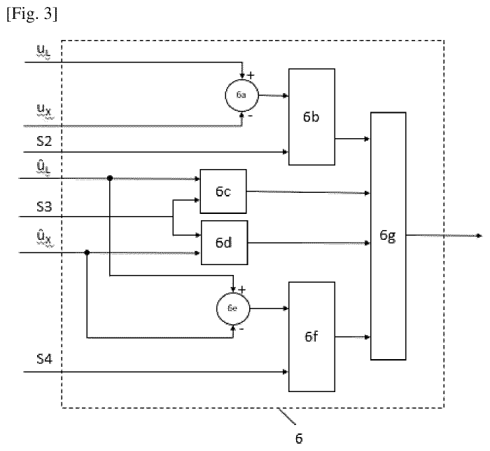

To achieve this, the outputs of the device 5a of the Kalman filter observer type can be reused as inputs of the detection device 6, illustrated by FIG. 3.

The detection device 6 comprises a first subtractor 6a determining the difference between the measurement of the first channel 3ia for measuring the redundant sensor and the measurement of the second channel 3ib for measuring the same redundant sensor.

A first comparison means 6b determines whether the difference between the measurement of the first channel 3ia for measuring the redundant sensor and the measurement of the second channel 3ib for measuring the same redundant sensor is lower than a second threshold S2. If such is the case, the first comparison means then sends a first signal intended for the logic gate 6g.

A second comparison means 6c determines whether the estimation of the bias of the first measurement channel û_{L} is higher than a third threshold S3. If such is the case, the second comparison means 6c then sends a first signal intended for the logic gate 6g.

A third comparison means 6d determines whether the estimation of the bias of the second measurement channel û_{X} is higher than the third threshold S3. If such is the case, the third comparison means 6d then sends a first signal intended for the logic gate 6g.

A second subtractor 6e determines the difference between the estimation of the bias of the first measurement channel û_{L} and the estimation of the bias of the second measurement channel û_{X}.

A fourth comparison means 6f determines whether the difference between the estimation of the bias of the first measurement channel û_{L} and the estimation of the bias of the second measurement channel û_{X} is lower than a fourth threshold S4, with a hysteresis taking into account the accuracy of the two channels for measuring the redundant sensor. Indeed, in the event of a failure of the actuator, the estimation of the two biases is supposed to be almost identical to the measurement error of the channels for measuring the nearest redundant sensor. The presence of the hysteresis makes it possible to take this into account. If such is the case, the fourth comparison means 6f then sends a first signal intended for the logic gate 6g.

The logic gate 6g transmits a signal when all of its inputs receive a first signal, and otherwise no signal, which makes it possible to detect the actuation failure.

The control system according to the invention may be configured to be applied to specific redundant sensors measuring the position of the Linear Variable Differential Transformers (LVDT) particularly comprising a Fuel Metering Valve (FMV) and Variable Stator Valves (VSV) of the high-pressure compressor. It can also be applied to the input temperature measurement of the high-pressure compressor, or to the input static pressure measurement of the combustion chamber of an aircraft engine.

1. System for controlling a device provided with at least one equipment item, the control system comprising at least one sensor each capable of measuring an operating quantity of the device, and two channels for measuring a redundant sensor for each equipment item, at least one embedded control means configured to determine a command intended for at least one equipment item as a function of the measurement of at least one operating quantity of the device and a selected measurement of the controlled equipment item, the control system further comprising a calculating means configured to determine the selected measurement of the at least one controlled equipment item, by means of a Kalman filter observer, as a function of the at least one measurement of the operating quantity of the device and the measurements of the channels for measuring a redundant sensor for the controlled equipment item, the calculating means being further configured to detect a failure of one of the channels for measuring the redundant sensor by applying a Kalman filter observer, as a function of the at least one measurement of the operating quantity of the device and of the measurements of the channels of the redundant sensor, for the controlled equipment item, so as to exclude therefrom the measurement channel.

2. Control system according to claim 1, wherein the device comprises at least two equipment items, the selected measurement of the at least two equipment items being determined by the same Kalman filter observer.

3. Control system according to claim 1, wherein the calculating means comprises:
a Kalman filter observer determining an estimation of a bias of the first measurement channel and an estimation of a bias of the second measurement channel as a function of the at least one measurement of the operating quantity of the device, of the measurement of the first channel for measuring the redundant sensor and of the measurement of the second channel for measuring the redundant sensor;
a comparison means configured to send a selection signal as a function of the comparison results of each bias estimation at a first predetermined threshold, of the result of the comparison of the absolute value of the difference of two measurement channels at a second predetermined threshold and of the bias estimations with one another; and
a selection device configured to transmit the selected measurement equal to the measurement of the first measurement channel, to the measurement of the second measurement channel or to the average of the measurements of the first measurement channel and of the second measurement channel as a function of a selection signal.

4. Control system according to claim 3, wherein the selection device comprises a calculating means configured to perform the average of the measurement of the first measurement channel and of the measurement of the second measurement channel, the selection device also comprising a logic gate receiving as input on the one hand the selection signal and on the other hand the measurement of the first measurement channel, the measurement of the second measurement channel and the average of the measurement of the first measurement channel and of the measurement of the first measurement channel, the logic gate being configured to send the selected measurement equal to one of the values received as input as a function of the selection signal.

5. System according to claim 3, wherein the comparison means is configured to perform the following steps:
when the absolute value of the difference between the measurement of the first measurement channel and the measurement of the second measurement channel is lower than a second predetermined threshold or none of the bias estimations are higher than a first predetermined threshold, the selection signal sent indicates to the selection device to transmit a selected measurement equal to the average of the measurements of the measurement channels;
when the absolute value of the difference between the measurement of the first measurement channel and the measurement of the second measurement channel is higher than a second predetermined threshold and the estimation of the bias of the first measurement channel is not higher than a first threshold, and the estimation of the bias of the second measurement channel is higher than the first threshold, the selection signal sent indicates to the selection device to transmit a selected measurement equal to the measurement of the first measurement channel;
when the absolute value of the difference between the measurement of the first measurement channel and the measurement of the second measurement channel is higher than a second predetermined threshold and the estimation of the bias of the first measurement channel is higher than the first threshold, and the estimation of the bias of the second measurement channel is not higher than the first threshold, the selection signal sent indicates to the selection device to transmit a selected measurement equal to the measurement of the second measurement channel;
when the absolute value of the difference between the measurement of the first measurement channel and the measurement of the second measurement channel is higher than a second predetermined threshold and the estimation of the bias of the first measurement channel is higher than the first threshold, when the estimation of the bias of the second measurement channel is higher than the first threshold, and when the estimation of the bias of the first measurement channel is not higher than the estimation of the bias of the second measurement channel, the selection signal sent indicates to the selection device to transmit a selected measurement equal to the measurement of the first measurement channel; and
when the absolute value of the difference between the measurement of the first measurement channel and the measurement of the second measurement channel is higher than a second predetermined threshold and the estimation of the bias of the first measurement channel is higher than the first threshold, when the estimation of the bias of the second measurement channel is higher than the first threshold, and when the estimation of the bias of the first measurement channel is higher than the estimation of the bias of the second measurement channel, the selection signal sent indicates to the selection device to transmit a selected measurement equal to the measurement of the second measurement channel.

6. Control system according to claim 1, wherein the comparison means is configured to perform the following steps: the estimations of the biases are stored at the moment when it is determined that the difference in absolute value between the measurement of the first measurement channel and the measurement of the second measurement channel is higher than a predetermined threshold and a selection signal is sent indicating to the selection device to transmit a selected measurement equal to the measurement of the channel for measuring the redundant sensor for which the absolute value of its estimation of the bias is the lowest.

7. Control system according to claim 1, wherein the comparison means is configured to perform the following steps: the estimations of biases are stored on a sliding window over time, when a predefined number of values are stored, the variance or the standard deviation of the estimations of the bias of the first measurement channel is determined and the variance or the standard deviation of the estimation of the bias of the second measurement channel is determined, the variances or the standard deviations obtained are compared and a selection signal is sent indicating to the selection device to transmit a selected measurement equal to the measurement of the channel for measuring the redundant sensor for which the variance or the standard deviation of the associated estimation of the bias takes the lowest value.

8. Control system according to claim 1, wherein the comparison means is configured to perform the following steps: the estimations of the bias are stored over time, when a predefined number of values are stored, the gradient of the estimations of the bias of the first measurement channel is determined and the gradient of the estimations of the bias of the second measurement channel is determined, the gradients obtained are compared and a selection signal is sent indicating to the selection device to transmit a selected measurement equal to the measurement of the channel for measuring the redundant sensor for which the gradient of the estimation of the associated bias is the lowest.

9. Control system according to claim 1, wherein the controlled equipment item is an actuator, the system comprises a Kalman filter observer determining an estimation of a bias of the first measurement channel and an estimation of a bias of the second measurement channel as a function of the at least one measurement of the operating quantity of the device, of the measurement of the first channel for measuring the redundant sensor and of the measurement of the second channel for measuring the redundant sensor, a detection device comprising:
a first subtractor determining the difference between the first channel for measuring the redundant sensor and the second channel for measuring the redundant sensor;
a first comparison means determining whether the difference between the measurement of the first channel for measuring the redundant sensor and the measurement of the second channel for measuring the redundant sensor is lower than a second threshold, if such is the case the first comparison means sends a first signal intended for a logic gate;
a second comparison means determining whether the estimation of the bias of the first measurement channel is higher than a third threshold, if such is the case the second comparison means sends a first signal intended for the logic gate;
a third comparison means determining whether the estimation of the bias of the second measurement channel is higher than the third threshold, if such is the case the third comparison means sends a first signal intended for the logic gate;
a second subtractor determining the difference between the estimation of the bias of the first measurement channel and the estimation of the bias of the second measurement channel;
a fourth comparison means determining whether the difference between the estimation of the bias of the first measurement channel and the estimation of the bias of the second measurement channel is lower than a fourth threshold, by a hysteresis taking into account the accuracy of the channels for measuring the redundant sensor, if such is the case the fourth comparison means sends a first signal intended for the logic gate; and
the logic gate transmitting a signal when all of its inputs receive a first signal, the logic gate not transmitting a signal when at least one of its inputs does not receive the first signal, which makes it possible to detect a failure of the actuator.

10. Control system according to claim 1, wherein the device is an aircraft engine and the channels for measuring the redundant sensor measure the position of the linear variable differential transformers, the position of the fuel metering valve, the variable stator valves of the high-pressure compressor of the engine, the measurement of the input temperature of the high-pressure compressor of the engine, or the input static pressure measurement of the combustion chamber of the engine.

11. Method for controlling a device provided with at least one equipment item, at least one sensor capable of measuring an operating quantity of the device, and channels for measuring the redundant sensor for each equipment item, the control method comprising the following steps of:
determining a command intended for at least one equipment item as a function of the at least one measurement of the operating quantity of the device and a selected measurement of the controlled equipment item; then
determining the selected measurement of the at least one controlled equipment item, by means of a Kalman filter observer, as a function of the at least one measurement of the operating quantity of the device and measurements of the channels for measuring the redundant sensor for the controlled equipment item.

12. Aircraft provided with a control system according to claim 1.
